(19) United States
(12) Patent Application Publication
(10) Pub. No.: US 2015/0257080 A1
(43) Pub. Date: Sep. 10, 2015

(54) ELECTRONIC INTERFACE BETWEEN COMMUNICATION NETWORKS AMONG VEHICLES

(71) Applicant: ALENIA AERMACCHI S.p.A., Venegono Superiore (VA) (IT)

(72) Inventors: Mauro Rostagno, Venegono Superiore (VA) (IT); Angelo Tricarico, Venegono Superiore (VA) (IT)

(21) Appl. No.: 14/417,686

(22) PCT Filed: Jul. 24, 2013
(86) PCT No.: PCT/IB2013/056081

§ 371 Date: Jan. 27, 2015

(30) Foreign Application Priority Data
Jul. 27, 2012 (IT) TO2012A000665

(51) Int. Cl. H04W 40/22; H04L 29/06; H04L 29/08

(52) U.S. Cl. CPC H04W 40/22; H04L 67/12; H04L 69/16; H04W 92/20

(57) ABSTRACT

An electronic interface device provides an interface between communication networks used by airplanes belonging to different groups. A proprietary simulation or training system operates on a first group of airplanes (VI) through a first ground station (T1). The airplanes of the first group and the ground station communicate with each other through a first communication network (R1). A second group of airplanes (V2) communicate with each other and with a second ground station (T2) through a communication network or system of the “LINK 16” type. The electronic interface device (TIS) couples the simulation system of the first group of airplanes to the “LINK 16” communication system of the second group of airplanes, thus extending to the airplanes equipped with the LINK 16 system the possibility of participating in training sessions with training airplanes equipped with the dedicated simulation and training systems.

The present invention relates to an electronic device to be used as an interfacing and processing unit between communication networks used by military airplanes. In particular, an electronic interface device providing an interface between communication networks of different types, at least one of which is used for training purposes.

Said data communication networks are networks for exchanging information between airplanes using the same protocol and between such airplanes and at least one ground station.

The application field concerns training activities for military pilots in real and/or virtual operation scenarios.

Military pilots are normally trained in a virtual tactical scenario generated by a simulation and planning system included in a specific ground station and transmitted via said communication network to all airplanes participating in the training.

Such simulation and training systems are dedicated to specific types of airplanes, capable of exchanging information with each other through a dedicated communication network that uses a predefined transmission frequency band and a predefined communication protocol. In these cases, the simulation system can only exchange information with that specific aircraft communication network.

When different airplanes are involved, which use different communication networks between them, it is not possible to apply an adequate simulation and training system for all the participating airplanes, in that the virtual scenario created by it would not be understood and interpreted by all airplanes.

Many military airplanes, such as, for example, the so-called “Eurofighter Typhoon” or the “Joint Strike Fighter—F35”, use a tactical communication network called “LINK 16”, which is a military communication system for information distribution among military means, in particular airplanes.

Said LINK 16 system requires the use of communication equipment called MIDS (Multifunctional Information Distribution System), which manages the information transmitted among airplanes with the possibility of communicating it to at least one ground station.

Of course, airplanes that do not use this tactical communication system cannot interface to airplanes that use it.

The present invention aims at providing an electronic interface device that allows extending to airplanes equipped with said LINK 16 system the possibility of participating in training sessions with training airplanes equipped with such dedicated simulation and training systems.

In particular, said interface device connects a ground station of the simulation and training system to a ground station of “LINK 16” system.

One aspect of the present invention relates to an electronic interface device having the features set out in the appended claim 1.

The features and advantages of the device according to the present invention will become more apparent from the following description of one typical implementation thereof, which is provided herein by way of non-limiting example with reference to the annexed drawings, wherein:

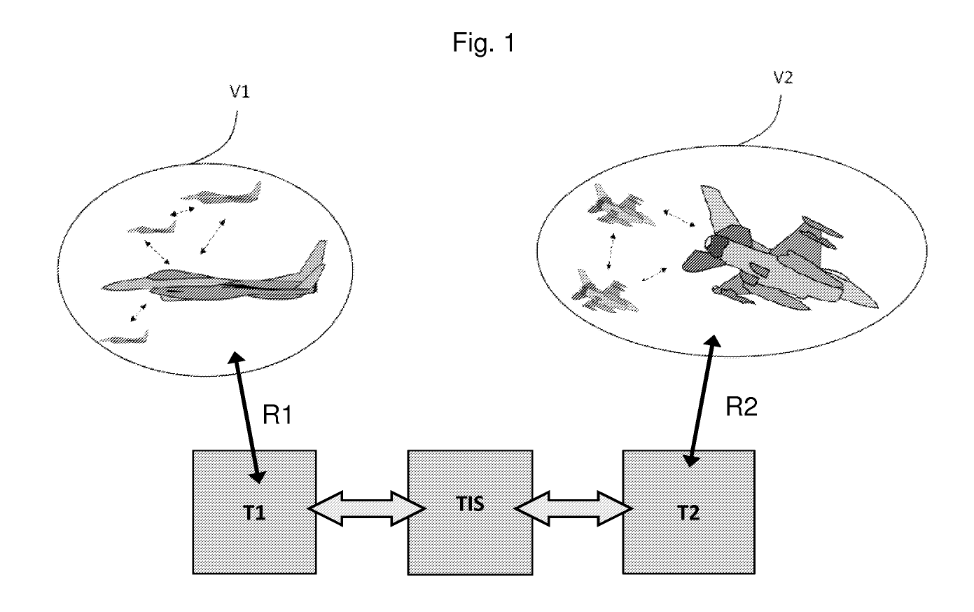

FIG. 1 shows the device used for coupling a simulation and training system comprising a first group of airplanes and a second group of airplanes communicating through a communication network or system of “LINK 16” type;

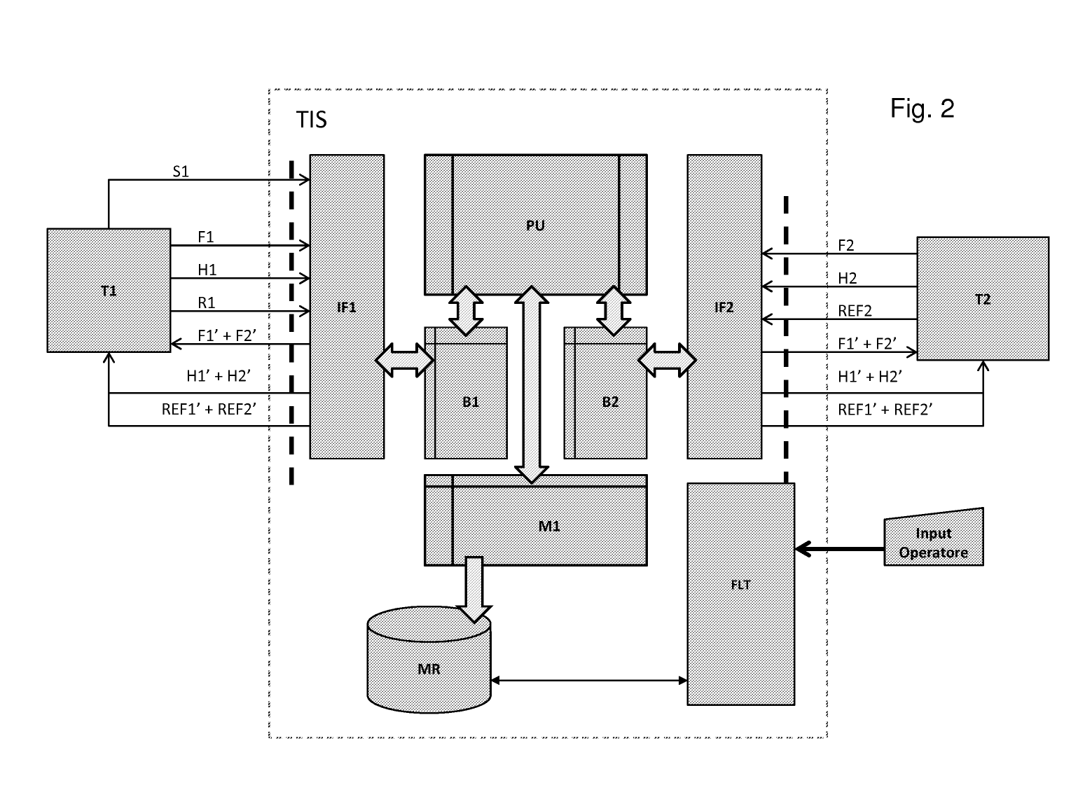

FIG. 2 is a block diagram of the principle of operation of the electronic interface device according to the present invention.

With reference to said block diagram (FIG. 1), V1 designates a first group of airplanes, on which a simulation or training system operates through a first ground station T1. Said airplanes and the ground station communicate with each other through a communication network R1 of their own.

One example of a simulation and training system is the system known as ETTS (Embedded Tactical Training System) fitted to airplanes known as M346, manufactured by the present Applicant and described in European patent no. 1436193.

Said system allows communication between airplanes and ground stations through a proprietary communication protocol, and allows simulating combat situations in verisimilar operation scenarios.

Said simulation system on M346 airplanes allows to involve real participants (airplanes in flight), virtual participants (simulated virtual airplanes) and remote participants (virtual airplanes controlled by pilots in flight simulators) in the tactical scenario generated.

A second group of airplanes V2 and a ground station T2 communicate with each other through “LINK 16” communication network or system R2.

According to the present invention, an electronic interface device TIS allows coupling the simulation system of the first group of airplanes to “LINK 16” communication system of the second group of airplanes, thereby allowing both groups of airplanes V1 and V2 to participate in joined training sessions.

In particular, said interface device connects the ground station of the simulation and training system to the ground station of “LINK 16” system.

Said “LINK 16” communication system is a system that allows at least the following data to be exchanged between the airplanes and between the airplanes and the respective ground station:
navigation data of the connected airplanes, e.g. airplane and target latitude and longitude, speed, acceleration, etc.
tactical and command data, e.g. assigned mission, target identification data and target priority.

These are, in fact, the same types of data as used by airplanes equipped with on-board tactical simulation in order to realistically build the virtual scenario in which the pilot will have to train during the mission.

In order to allow for mutual integration of both systems, therefore, the ground station of LINK 16 communication network will provide the following data:
scenario selection,
simulation type selection,
simulation start and stop control,
system error monitoring,
sensor control and output signal selection,
real-time recording of the data exchanged during the operations for future analysis.

According to the present invention, electronic interface device TIS can exchange such data with the simulation system.

The ground equipment including electronic interface device TIS can be implemented on computer applications or the like. Communication between the interface device, the simulation system and the ground station of LINK 16 system can advantageously take place through a fast Ethernet communication using the TCP/IP protocol, or through any other interface means ensuring data transmission speeds of no less than 10 Mbit/sec.

In particular, with reference to the basic diagram shown in FIG. 2, it is assumed that the simulation and training ground station T1 represents the main reference (“Master”) in the scenario and feeds the TIS with the following types of parameters:
General scenario data (S1)
Friendly platform data (F1)
Enemy platform (or target) data (H1)
Significant or reference point data (REF1)

Likewise, it is assumed that “LINK 16” ground station, acting as a secondary station (“Slave”), provides the TIS with its own parameters classified in the following types:
Friendly platform data (F2)
Enemy platform (or target) data (H2)
Significant or reference point data (REF2)

Note: Only actions and information resulting from interaction between the two airplane networks, and therefore not LINK 16 scenario data, are forwarded to the TIS, since it is assumed that at the beginning of training session T1 and T2 have predefined scenarios which are as similar as possible to each other, and that afterwards only scenario T1, which is the “Master”, will update the scenario controls while processing information F2, H2 and REF2 received from T2.

Still with reference to the basic diagram shown in FIG. 2, the electronic interface device is composed internally of at least the following sub-blocks:
interface module IF1 for reading and extracting parameters S1, F1, H1 and REF1 coming from T1;
temporary memory buffer B1 for parameters S1, F1, H1, REF1;
interface module IF2 for reading and extracting parameters F2, H2 and REF2 coming from T2;
temporary memory buffer B2 for parameters F2, H2, REF2;
computing or processing unit or process for track correlation and merging PU;
shared memory M1 for storing the tracks resulting from the computation carried by unit PU;
memory for (off-line) recording of classified tracks MR;
message or parameter setting and filtering unit FLT, including a unit for loading and reading message filtering variables.

Electronic interface device TIS thus composed first acquires, extrapolates and stores data S1, F1, H1, REF1, via blocks IF1 and B1, and data F2, H2 and REF2, via blocks IF2 e B2. Such parameters are then read and processed by processing unit PU, which correlates the data of the two sources with each other and with the internal memory where previous data have been saved, by making comparisons between identifiers, positions, speeds, etc. Any data which are recognized as referring to the same object are merged and updated in accordance with predefined criteria. The other data, which are not present in either one of the two simulations, are added, copied separately or discarded, still in accordance with predefined criteria. The data catalogue thus built and updated is then dumped into a shared RAM memory, which stores a consistent and univocal database of all simulation tracks. Advantageously, the data contained in this shared memory M1 can be saved to the non-volatile memory MR for after-training recording and analysis.

The original parameters, which have been updated according to the computations carried out by unit PU, thus becoming S1′, F1′, H1′ and REF1′, are added with the data F2′, H2′ and REF2′, and all data are re-sent to ground station T1, possibly after having been filtered by FLT in accordance with the criteria set by the operator. All data are formatted by interface module IF1 so as to be compatible with system T1.

Likewise, F2′, H2′ and REF2′ are added to data F1′, H1′ and REF1′ and re-sent together to ground station T2, also in this case after having been filtered by FLT. All data are formatted by interface module IF2 so as to be compatible with system T2.

At this point, systems T1 and T2 have been synchronized with each other and can independently transmit the parameters received from the respective airplane networks V1 and V2, such that they can virtually interact with each other as if they belonged to the same simulation and training scenario and to the same simulation and training communication network.

1. Electronic interface device providing an interface between communication networks used by airplanes belonging to different groups, wherein a proprietary simulation or training system operates on a first group of airplanes through a first ground station, said airplanes of the first group and the ground station communicating with each other through a first communication network
a second group of airplanes communicating with each other and with a second ground station through a communication network or system of the “LINK 16” type, said electronic interface device couples the simulation system of the first group of airplanes to the “LINK 16” communication system of the second group of airplanes, to enable the airplanes equipped with said LINK 16 system to participate in training sessions with training airplanes equipped with said dedicated simulation and training systems,
wherein said device connects the ground station of the simulation and training system to the ground station of the “LINK 16” system.

2. The electronic interface device according to claim 1, wherein said interface categorizes, correlates, filters and resends to the ground stations at least the following generic flight parameters:
navigation data of the connected airplanes, e.g. airplane and target latitude and longitude, speed, acceleration,
virtual tactical and command data, e.g. assigned mission, target identification data and target priority.
reference point data.

3. The electronic interface device according to claim 1, wherein the device communicates with the simulation system and with the ground station of the LINK 16 system through an Ethernet communication using the TCP/IP protocol.

4. The electronic interface device according to claim 1, wherein the LINK 16 system transmits to said device latitude and the longitude of the airplanes of the second group and target, speed, and acceleration.

5. The electronic interface device according to claim 1, wherein the LINK 16 system transmits to said device, for the airplanes of the second group, the assigned mission, the target identification data and the target priority.

6. The electronic interface device according to claim 1, wherein the electronic interface device is implemented through software applications executed in a personal computer.

7. The electronic interface device according to claim 1, wherein the device is adapted to read and interpret parameters received according to a proprietary protocol and data mapping, in accordance with the standards of the training station.

8. The electronic interface device according to claim 1, wherein the device is adapted to read and interpret parameters received according to a proprietary protocol and data mapping, in accordance with the standards of the LINK 16 ground station.

9. The electronic interface device according to claim 1, comprising at least one interface module for reading and extracting the parameters coming from the first ground station, at least one interface module for reading and extracting the parameters coming from the second ground station, at least one computing or processing unit for track correlation and merging, acquiring, correlating, merging, summing, sorting and classifying the data coming from the two ground stations.

10. The electronic interface device according to claim 1, wherein the device is adapted to re-transmit parameters received, correlated and re-processed according to a proprietary protocol and data mapping, in accordance with the standards of the LINK 16 ground station, to the ground stations according to the appropriate protocols.
